(19) United States
(12) Patent Application Publication
(10) Pub. No.: US 2025/0124917 A1
(43) Pub. Date: Apr. 17, 2025

(54) VOICE RECOGNITION DEVICE AND COMPUTER-READABLE RECORDING MEDIUM

(71) Applicant: FANUC CORPORATION, Yamanashi (JP)

(72) Inventor: Yasuhiro SHIBASAKI, Yamanashi (JP)

(21) Appl. No.: 18/833,395

(22) PCT Filed: Feb. 8, 2022
(86) PCT No.: PCT/JP2022/004938

§ 371 Date: Jul. 26, 2024

(51) Int. Cl. G10L 15/22; G10L 15/26; G10L 21/00

(52) U.S. Cl. CPC G10L 15/22; G10L 15/26; G10L 21/00; G10L 2015/223

(57) ABSTRACT

A voice recognition device according to the present disclosure performs voice recognition on a voice signal inputted on manufacturing premises and uses the result as a voice command, the voice recognition device comprising: an adjustment waveform group generation unit for performing a plurality of different adjustments on a prescribed attribute of an inputted voice signal and generating a plurality of adjusted voice signals corresponding to the same; and a voice recognition unit for performing voice recognition on the plurality of adjusted voice signals and the voice signal outputted by the adjustment waveform group generation unit. The adjustment performed by the adjustment waveform group generation unit includes, as an attribute to be adjusted, the speech speed.

### RELATED APPLICATIONS

The present application is a National Phase of International Application No. PCT/JP2022/004938 filed Feb. 8, 2022.

### TECHNICAL FIELD

The present invention relates to a voice recognition device and a computer readable storage medium.

### BACKGROUND ART

In industrial fields such as manufacturing industries, currently, various devices such as robots, transport machines, machine tools, machine facilities, and the like are working. Most of such devices include an operation unit, and devices that control respective devices such as a Programmable Logic Controller (PLC), a Numerical Controller (NC), a control panel, and the like also include the operation unit.

Operation units of devices have many buttons or operation windows and require complex operation, and it may take time to learn the operation. Voice input interfaces enable intended operation to be performed with only utterance of a voice command. Thus, attempts have been made to improve operability with voice input interfaces.

Voice commands used in operation of devices can be assumed in accordance with a type of a device using voice commands, a site where a device is installed, details in operating a device, or the like. Thus, an assumed voice command can be created with grammar (syntax and words). For example, see Patent Literature 1.

### CITATION LIST

### Patent Literature

Patent Literature 1: Japanese Patent Application Laid-Open No. H9-325787

### SUMMARY OF INVENTION

### Technical Problem

As factors determining characteristics of voice to be recognized, there are various attributes such as a voice section cutout position, a manner of addition of background noise, an utterance speed, or the like. A slight shift in these attributes may disturb a voice recognition result (a transcribed text, reliability, or the like). Such a disturbance leads to a reduction in the accuracy rate of voice recognition.

In manufacturing sites, such a shift may occur in the above attributes because of phenomena due to factors such as the number or the type of machines running in the environment, operation made by operators, or the like. Thus, in development of an application related to voice recognition used in a manufacturing site or in adjustment during on-site operation, the reproducibility of phenomena occurring in the manufacturing site will be important for improving accuracy of voice recognition. Occurrence of the above disturbance reduces the reproducibility of error recognition in voice recognition. As a result, failure investigation or the like of a voice recognition process will be difficult. As discussed above, unlike general use at home or office sites, randomness of recognition results is likely to be a problem in applications of voice recognition used in industrial fields such as manufacturing industries.

Accordingly, a voice recognition technology that can overcome a disturbance in recognition results is desired in manufacturing sites.

### Solution to Problem

A voice recognition device according to the present invention generates a plurality of voice signals by finely adjusting a predetermined attribute (waveform parameter) of an input voice signal and causes respective adjusted voice signals to be subjected to voice recognition. The voice recognition device then determines the most frequent value in recognition results for these adjusted voice signals as a correct recognition result and thereby solves the above problem.

Further, one aspect of the present disclosure is a voice recognition device that performs voice recognition on a voice signal input at a manufacturing site and uses the voice signal as a voice command, the voice recognition device includes: an adjusted waveform group generation unit that performs multiple different types of adjustment on a predetermined attribute of the input voice signal and generates a plurality of adjusted voice signals corresponding to the multiple different types of adjustment; and a voice recognition unit that performs voice recognition on the voice signal and the plurality of adjusted voice signals output by the adjusted waveform group generation unit, and the adjustment performed by the adjusted waveform group generation unit includes adjustment of an utterance speed as an attribute to be adjusted.

Another aspect of the present disclosure is a computer readable storage medium storing a program executed by a voice recognition device that performs voice recognition on a voice signal input at a manufacturing site and uses the voice signal as a voice command, and the program causes a computer to function as: an adjusted waveform group generation unit that performs multiple different types of adjustment on a predetermined attribute including an utterance speed of the input voice signal and generates a plurality of adjusted voice signals corresponding to the multiple different types of adjustment; and a voice recognition unit that performs voice recognition on the voice signal and the plurality of adjusted voice signals output by the adjusted waveform group generation unit.

### Advantageous Effects of Invention

According to one aspect of the present disclosure, the processing accuracy of voice recognition is made robust even when a disturbance occurs in a predetermined attribute of a voice waveform. Thus, the accuracy rate of voice recognition is also expected to improve.

### BRIEF DESCRIPTION OF DRAWINGS

FIG. 1 is a schematic hardware configuration diagram of a voice recognition device according to one embodiment of the present invention.

FIG. 2 is a schematic block diagram illustrating functions of the voice recognition device according to one embodiment of the present invention.

FIG. 3 represents an example of an adjustment scheme information registration window.

FIG. 4 represents an example of an aggregation scheme information registration window.

FIG. 5 is a diagram illustrating an example aggregated by the most frequent value of transcribed texts.

FIG. 6 is a diagram illustrating an example aggregated by the median of reliability of transcribed texts.

FIG. 7 a schematic block diagram illustrating functions of a voice recognition device according to another embodiment of the present invention.

### DESCRIPTION OF EMBODIMENTS

Embodiments of the present invention will be described below with reference to the drawings.

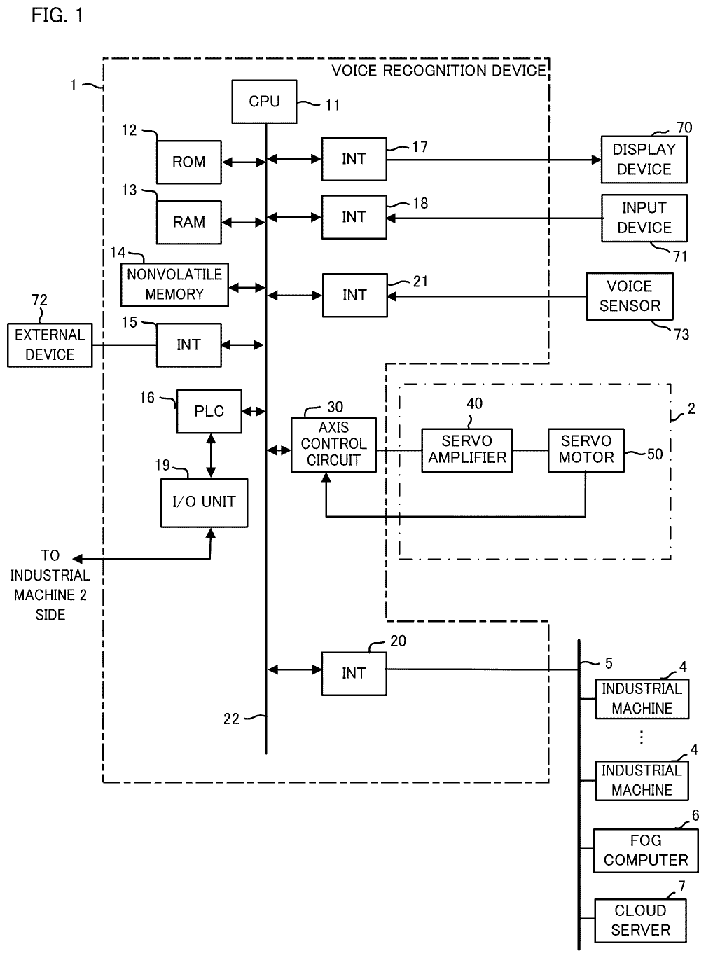

FIG. 1 is a schematic hardware configuration diagram illustrating the main part of a voice recognition device according to one embodiment of the present invention. A voice recognition device 1 according to the present embodiment can be implemented on a control device that controls an industrial machine 2 installed in a manufacturing site such as a factory. Further, the voice recognition device 1 can be implemented on a personal computer installed together with a control device or on a computer such as a fog computer 6, a cloud server 7, or the like connected to a control device via a wired or wireless network. In the following, the voice recognition device 1 according to the present embodiment will be described based on an example in which the voice recognition device 1 is implemented on a control device that controls the industrial machine 2.

A CPU 11 of the voice recognition device 1 according to the present embodiment is a processor that controls the voice recognition device 1 as a whole. The CPU 11 reads a system program stored in a ROM 12 via a bus 22 and controls the entire voice recognition device 1 in accordance with the system program. A RAM 13 temporarily stores temporary calculation data or display data, various externally input data, and the like.

A nonvolatile memory 14 is formed of a memory backed up by a battery (not illustrated), a solid state drive (SSD), or the like, for example, and the storage state thereof is maintained even when the voice recognition device 1 is powered off. The nonvolatile memory 14 stores data acquired from the industrial machine 2, a control program or data loaded from an external device 72 via an interface 15, a control program or data input via an input device 71, a control program or data acquired from other devices via a network 5, or the like. The control program or data stored in the nonvolatile memory 14 may be loaded into the RAM 13 during execution/during use. Further, various system programs such as a known analysis program are written in advance in the ROM 12.

The interface 15 is an interface for connecting the CPU 11 of the voice recognition device 1 and the external device 72 such as a USB device to each other. For example, a control program, setup data, or the like used for controlling the industrial machine 2 are loaded from the external device 72 side. Further, the control program, the setup data, or the like edited within the voice recognition device 1 can be stored in an external storage unit via the external device 72. A programmable logic controller (PLC) 16 executes a ladder program to output signals to the industrial machine 2 and peripheral devices of the industrial machine 2 (for example, a tool exchanger, an actuator such as a robot, a plurality of sensors 3 such as a temperature sensor or a humidity sensor attached to the industrial machine 2) via an I/O unit 19 and to control the industrial machine 2. Further, in response to receiving a signal from various switches of an operation panel deployed to the main body of the industrial machine 2, a signal from peripheral devices, or the like, the PLC 16 performs a necessary process on the signal and then transfers the processed signal to the CPU 11.

An interface 20 is an interface for connecting the CPU of the voice recognition device 1 and the wired or wireless network 5 to each other. Other industrial machines 4 such as a machine tool or an electric discharge machine, the fog computer 6, the cloud server 7, and the like are connected to the network 5 and transfer data to and from the voice recognition device 1.

Data or the like obtained as the result of execution of data, a program, or the like loaded on a memory are output to and displayed on a display device 70 via the interface 17. Further, the input device 71 formed of a keyboard, a pointing device, or the like transfers an instruction, data, or the like based on operation made by an operator to the CPU 11 via the interface 18.

An interface 21 is an interface for connecting the CPU 11 of the voice recognition device 1 and a voice sensor 73 to each other. The voice sensor 73 may be, for example, a sound collecting instrument such as a microphone. For example, the voice sensor 73 may be attached to the input device 71 or a machine operating panel, a pendant (portable machine operating panel), or the like (not illustrated). A voice of an operator detected by the voice sensor 73 is transferred to the CPU 11 as a voice signal.

A axis control circuit 30 for controlling a axis of the industrial machine 2 outputs an instruction on the axis to a servo amplifier 40 in response to receiving a axis motion instruction amount from the CPU 11. In response to receiving this instruction, the servo amplifier 40 drives a servo motor 50 that moves the axis of a machine tool. The servo motor 50 of the axis has a built-in position and speed detector and feeds a position and speed feedback signal from this position and speed detector back to the axis control circuit 30 to perform feedback control of the position and speed. Note that, although only a single set of the axis control circuit 30, the servo amplifier 40, and the servo motor 50 is illustrated in the hardware configuration diagram of FIG. 1, the number of prepared sets of the same corresponds to the number of axis provided to the industrial machine 2 to be controlled in the actual implementation.

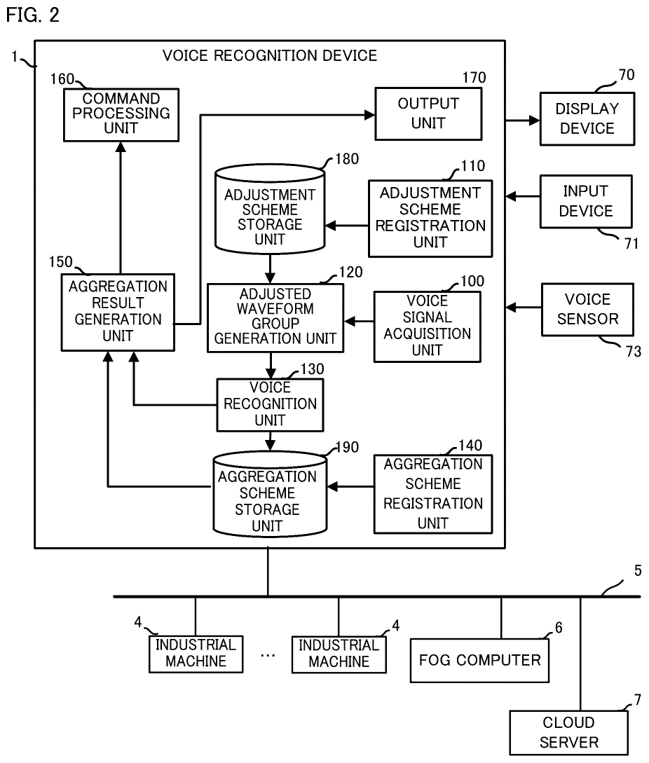

FIG. 2 illustrates functions of the voice recognition device 1 according to one embodiment of the present invention as a schematic block diagram. Each function of the voice recognition device 1 according to the present embodiment is implemented when the CPU 11 of the voice recognition device 1 illustrated in FIG. 1 executes the system program and controls the operation of each unit of the voice recognition device 1.

The voice recognition device 1 of the present embodiment includes a voice signal acquisition unit 100, an adjustment scheme registration unit 110, an adjusted waveform group generation unit 120, a voice recognition unit 130, an aggregation scheme registration unit 140, an aggregation result generation unit 150, a command processing unit 160, and an output unit 170. Further, in the RAM 13 or the nonvolatile memory 14 of the voice recognition device 1, an adjustment scheme storage unit 180, which is an area for storing adjustment scheme data registered by the adjustment scheme registration unit 110, and an aggregation scheme storage unit 190, which is an area for storing aggregation scheme data registered by the aggregation scheme registration unit 140, are prepared.

The voice signal acquisition unit 100 acquires a voice signal detected by the voice sensor 73 and then extracts a voice signal recognized as one time of utterance from the acquired voice signal. The voice signal detected by the voice sensor 73 is mainly based on speech uttered by an operator. The voice signal acquisition unit 100 may cut a voice signal corresponding to one time of utterance of the operator out of the detected voice signal. To achieve this, for example, a section in which a voice signal with a predetermined level Lvₜₕ that is predefined or lower continues for a predetermined period Tsₜₕ that is predefined or longer may be determined as a pause in voice, and the voice signal continuing for a predetermined period Tnₜₕ or longer interposed between pauses of the voice may be cut out as a voice signal corresponding to one time of utterance. Further, other known analysis technologies of voice signals may be used for cutting out of voice. The voice signal cut out by the voice signal acquisition unit 100 is output to the adjusted waveform group generation unit 120.

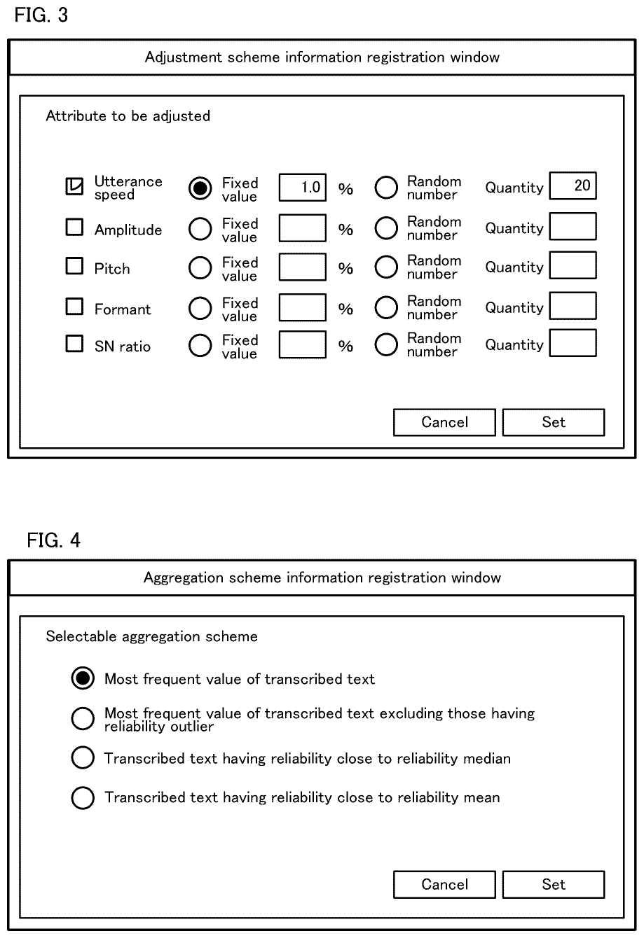

The adjustment scheme registration unit 110 accepts voice waveform information related to the adjustment scheme and registers this information related to the adjustment scheme to the adjustment scheme storage unit 180. The information related to the adjustment scheme includes information related to the attribute on a voice signal to be adjusted and information related to the adjustment level on the attribute. The attribute to be adjusted may be, for example, an utterance speed, an amplitude, a pitch, a formant, and SN ratio, or the like. For example, the adjustment scheme registration unit 110 accepts whether or not the respective attributes are to be adjusted and what degree of the adjustment level is applied for the adjustment on an attribute when the attribute is to be adjusted. The accepted input is then used as the information related to the adjustment scheme. For the information related to the adjustment level, random numbers, rather than a fixed value, that have the maximum value corresponding to a predetermined adjustment level may be specified for use. The information related to the adjustment scheme may include the number of adjusted voice signals to be further generated. As illustrated in FIG. 3 as an example, the adjustment scheme registration unit 110 may display interface used for accepting input on the display device 70. Note that typical information related to the adjustment scheme may be stored in the adjustment scheme storage unit 180 in advance. In such a case, the function of the adjustment scheme registration unit 110 is unnecessary except for when changing the adjustment scheme.

The adjusted waveform group generation unit 120 generates a plurality of adjusted voice signals in which voice signals input from the voice signal acquisition unit 100 have been adjusted in accordance with information related to the adjustment scheme stored in the adjustment scheme storage unit 180. For example, as illustrated in FIG. 3 as an example, it is assumed that the utterance speed is defined as an attribute to be adjusted, and information related to the adjustment scheme where the adjustment level is ±1.0% is stored in the adjustment scheme storage unit 180. In such a case, the adjusted waveform group generation unit 120 generates an adjusted voice signal where the utterance speed of an input voice signal is at 101%, an adjusted voice signal where the utterance speed is at 99%, an adjusted voice signal where the utterance speed is at 102%, an adjusted voice signal where the utterance speed is at 98%, and so on, respectively. When it is specified to use random numbers for adjustment levels, an adjustment level can be found sequentially from the random numbers to determine an adjustment amount. The same applies to the amplitude. The pitch, the formant, or the like can be changed by a known method for pitch shift or formant shift, such as Synchronized OverLap-Add method (SOLA) or Phase Vocoder (PV). The SN ratio can be changed by considering components having a predetermined amplitude or less in a voice signal as noise and changing the level of these components. Other attributes of a voice signal can also be changed by a known method. When the number of adjusted voice signals to be generated is included in the information related to the adjustment scheme, adjusted voice signals for the number specified therein are generated. When the number of adjusted voice signals is not included, a predetermined number of adjusted voice signals that is predefined may be generated. The adjusted waveform group generation unit 120 outputs the original voice signal and a plurality of adjusted voice signals to the voice recognition unit 130 as data related to an adjusted waveform group.

The voice recognition unit 130 performs a known voice recognition process on respective voice signals (the original voice signal and a plurality of adjusted voice signals) included in data related to a group of adjusted waveforms input from the adjusted waveform group generation unit 120. The voice recognition unit 130 then outputs results of the voice recognition on respective voice signals to the aggregation result generation unit 150. The voice recognition process performed by the voice recognition unit 130 may be a process using a known model such as, for example, Dynamic Programming (DP) matching, Hidden Markov Model (HMM), Gaussian Mixture Model (GMM)-HMM, Deep Nural Network (DNN)-HMM, Recurrent Neural Network (RNN), Long Short-Term Memory (LSTM), or the like.

The aggregation scheme registration unit 140 accepts information related to aggregation scheme indicating what statistical processing is used to aggregating results obtained by the voice recognition unit 130 performing voice recognition on respective voice signals included in data related to a group of adjusted waveforms and registers the information related to aggregation scheme to the aggregation scheme storage unit 190. The information related to aggregation scheme includes information related to a statistical process that can aggregate results into one result based on at least a plurality of data. As an example, the information related to aggregation scheme may be information specifying a transcribed text corresponding to the most frequent value in a group of transcribed texts as the result of voice recognition. Further, as another example, the information related to aggregation scheme may be information specifying a transcribed text close to the median of reliability of respective transcribed texts as the result of voice recognition. As discussed above, the information related to aggregation scheme may be based on a predetermined statistical process performed on transcribed texts or reliability as the result of voice recognition. As illustrated in FIG. 4 as an example, the aggregation scheme registration unit 140 may display, on the display device 70, an interface for accepting input. Note that typical information related to aggregation scheme may be stored in the aggregation scheme storage unit 190 in advance. In such a case, the function of the aggregation scheme registration unit 140 is unnecessary except for when changing the aggregation scheme.

The aggregation result generation unit 150 performs a predetermined statistical process on results of voice recognition for data related to a group of adjusted waveforms performed by the voice recognition unit 130 in accordance with information related to aggregation scheme stored in the aggregation scheme storage unit 190. The aggregation result generation unit 150 then outputs the result of the statistical process as an aggregation result.

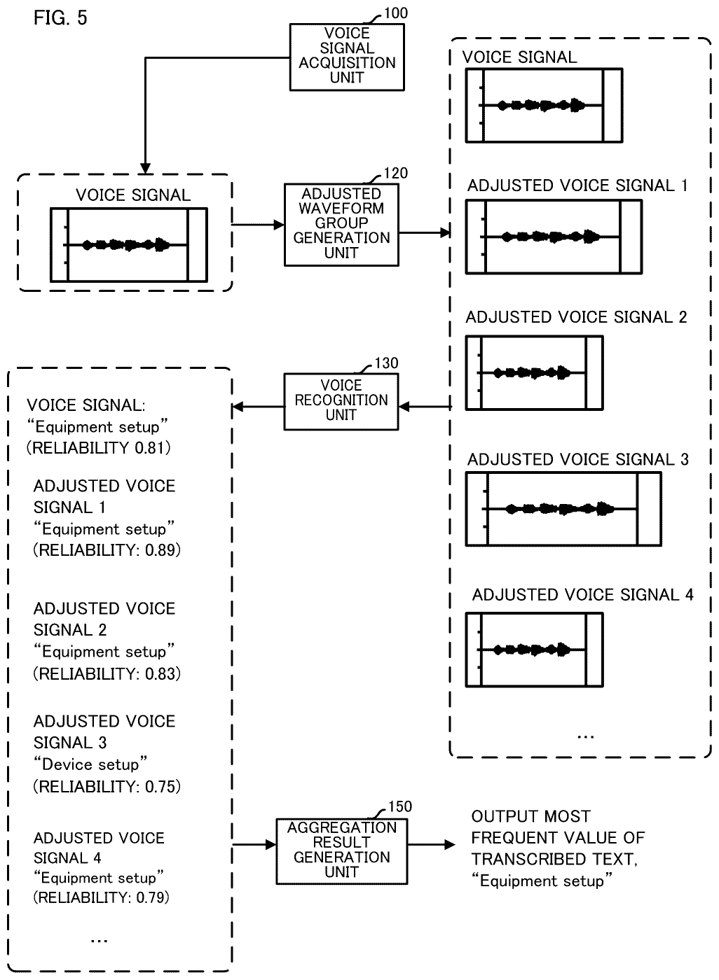

FIG. 5 illustrates an example when a transcribed text corresponding to the most frequent value in a group of transcribed texts as a result of voice recognition is specified as the information related to aggregation scheme. Once a voice signal output by the voice signal acquisition unit 100 is input to the adjusted waveform group generation unit 120, the adjusted waveform group generation unit 120 generates a plurality of voice signals in which predetermined attributes of the input voice signal have been adjusted in accordance with the information related to the adjustment scheme stored in the adjustment scheme storage unit 180. In the example of FIG. 5, a plurality of adjusted voice signals in which utterance speeds have been adjusted with predetermined adjustment levels are generated. These voice signals and the plurality of adjusted voice signals are then output to the voice recognition unit 130 as data related to the group of adjusted waveforms. In the voice recognition unit 130, a voice recognition process is performed on respective voice signals included in the group of adjusted waveforms. As a result, transcribed texts recognized from respective voice signals and the reliability thereof are obtained. The aggregation result generation unit 150 performs an aggregation process for finding a transcribed text corresponding to the most frequent value of the transcribed texts on these results of voice recognition. Since the most frequent value of the transcribed texts is “Equipment setup”, the aggregation result generation unit 150 outputs a transcribed text “Equipment setup” as the result of the aggregation process.

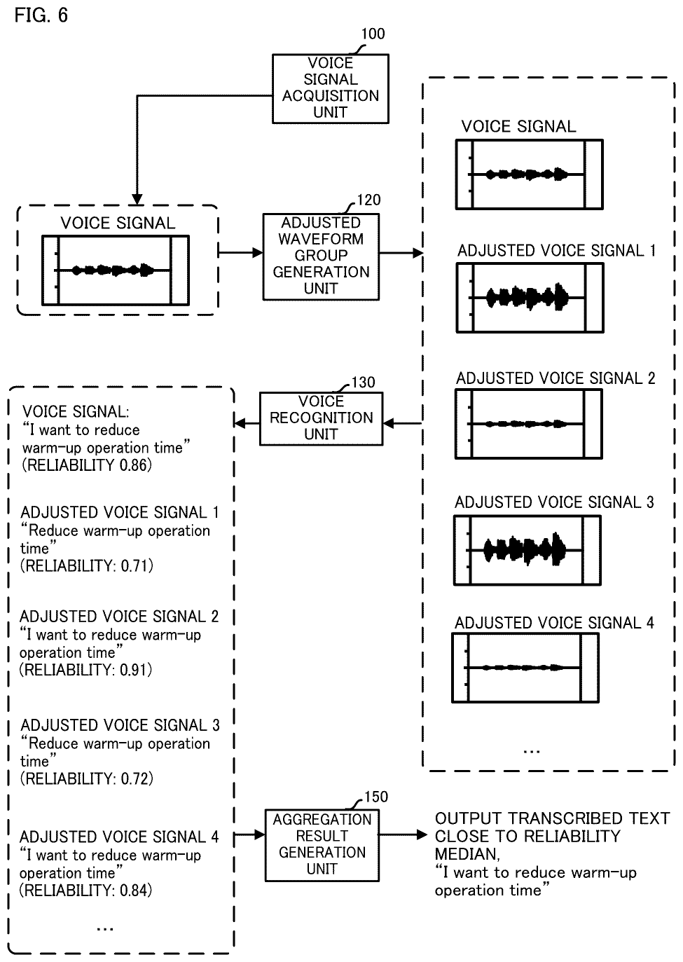

FIG. 6 illustrates an example when a transcribed text close to the median of reliability of respective transcribed texts as a result of voice recognition is specified as the information related to aggregation scheme. Once a voice signal output by the voice signal acquisition unit 100 is input to the adjusted waveform group generation unit 120, the adjusted waveform group generation unit 120 generates a plurality of voice signals in which predetermined attributes of the input voice signal have been adjusted in accordance with the information related to the adjustment scheme stored in the adjustment scheme storage unit 180. In the example of FIG. 6, a plurality of adjusted voice signals in which amplitude values have been adjusted with predetermined adjustment levels are generated. These voice signals and the plurality of adjusted voice signals are then output to the voice recognition unit 130 as data related to the group of adjusted waveforms. In the voice recognition unit 130, a voice recognition process is performed on respective voice signals included in the group of adjusted waveforms. As a result, transcribed texts recognized from respective voice signals and the reliability thereof are obtained. The aggregation result generation unit 150 performs an aggregation process for finding the median of reliability on these results of voice recognition. It is here assumed that the median of the reliability value is 0.81. In this case, the aggregation result generation unit 150 outputs “I want to reduce warm-up operation time”, as the result of the aggregation process, which is a transcribed text of the voice recognition result of the adjusted voice signal 4 that is the voice recognition result having the reliability value closest to 0.81.

The command processing unit 160 accepts, as a voice command, an aggregation result output from the aggregation result generation unit 150. In accordance with the accepted voice command, the command processing unit 160 then performs a predetermined function corresponding to the voice command. The predetermined function may be a general function of a control device. For example, the predetermined function may be a function to call a predetermined window of the voice recognition device, a function of setting a predetermined parameter, a function related to control to the industrial machine 2, or the like.

The output unit 170 outputs and displays an aggregation result output from the aggregation result generation unit 150 on the display device 70. The output unit 170 may display an aggregation result at a position that does not interfere with the display of a predetermined function being performed on the screen of the display device 70 (for example, a status display area on the lowermost part in the screen or the like). Further, the aggregation result may be output and displayed in a form of a dialog or the like. The output unit 170 may output and transmit the aggregation result to another industrial machine 4 or the upper-level computer such as the fog computer 6 or the cloud server 7 via the network 5. Further, the aggregation result may be output to a log storage area provided in advance on the nonvolatile memory 14 or the like.

The voice recognition device 1 including the above configuration generates a plurality of adjusted voice signals having waveforms similar to the acquired voice signal for the acquired voice signals. Next, the voice recognition device 1 performs a voice recognition process on a group of generated adjusted waveforms. The voice recognition device 1 then performs a predetermined statistical process on the results of the voice recognition process, and thereby the processing accuracy of voice recognition is made robust even when a disturbance occurs in a predetermined attribute of a voice signal based on the environmental factor of the manufacturing site. Thus, the accuracy rate of voice recognition is also expected to improve.

Although the embodiment of the present invention has been described above, the present invention is not limited to only the example of the embodiment described above and can be implemented in various ways with addition of suitable modification.

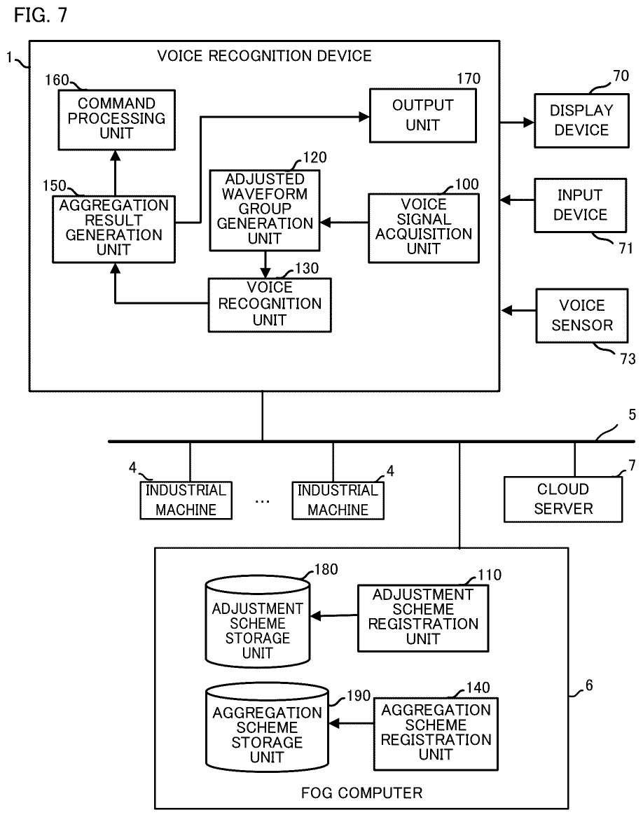

For example, in the embodiment described above, the example in which all the functions are possessed by the voice recognition device 1 has been illustrated. However, some of the functions may be configured to be provided on another computer such as the fog computer 6 or the cloud server 7. For example, as illustrated in FIG. 7 as an example, the adjustment scheme registration unit 110, the aggregation scheme registration unit 140, the adjustment scheme storage unit 180, and the aggregation scheme storage unit 190 may be provided on the fog computer, and the information related to the adjustment scheme or the information related to aggregation scheme may be shared and used by a plurality of voice recognition devices 1 (control devices).

1. A voice recognition device that performs voice recognition on a voice signal input at a manufacturing site and uses the voice signal as a voice command, the voice recognition device comprising:
an adjusted waveform group generation unit that performs multiple different types of adjustment on a predetermined attribute of the input voice signal and generates a plurality of adjusted voice signals corresponding to the multiple different types of adjustment; and
a voice recognition unit that performs voice recognition on the voice signals and the plurality of adjusted voice signals output by the adjusted waveform group generation unit,
wherein the adjustment performed by the adjusted waveform group generation unit includes adjustment of an utterance speed as an attribute to be adjusted.

2. The voice recognition device according to claim 1, wherein the adjustment performed by the adjusted waveform group generation unit is to add a change determined by a random number to the attribute to be adjusted.

3. The voice recognition device according to claim 1 further comprising an aggregation result generation unit that performs a statistical process in accordance with a predetermined aggregation scheme on a group of recognition results recognized by the voice recognition unit for the voice signal and the plurality of adjusted voice signals.

4. The voice recognition device according to claim 3, wherein the aggregation result generation unit outputs the most frequent value in a group of transcribed text results.

5. The voice recognition device according to claim 3, wherein the aggregation result generation unit outputs the median in a group of transcription result reliability group.

6. The voice recognition device according to claim 3 further comprising an output unit that presents a result of the statistical process performed by the aggregation result generation unit to a user.

7. The voice recognition device according to claim 1 further comprising an adjustment scheme registration unit that accepts and registers user input for the attribute and an adjustment level of the adjustment to be adjusted.

8. The voice recognition device according to claim 3 further comprising an aggregation scheme registration unit that accepts and registers user input for the aggregation scheme.

9. A computer readable storage medium storing a program executed by a voice recognition device that performs voice recognition on a voice signal input at a manufacturing site and uses the voice signal as a voice command, the program causing a computer to function as:
an adjusted waveform group generation unit that performs multiple different types of adjustment on a predetermined attribute including an utterance speed of the input voice signal and generates a plurality of adjusted voice signals corresponding to the multiple different types of adjustment; and
a voice recognition unit that performs voice recognition on the voice signal and the plurality of adjusted voice signals output by the adjusted waveform group generation unit.
